(19) United States
(12) Patent Application Publication
(10) Pub. No.: US 2025/0322057 A1
(43) Pub. Date: Oct. 16, 2025

(54) SYSTEMS AND METHODS FOR IMPLEMENTING SECURE PERFORMANCE COUNTERS FOR GUEST VIRTUAL MACHINES

(71) Applicant: ATI Technologies ULC, Markham (CA)

(72) Inventors: Shivam Swami, Markham (CA); Alexandru Radu, Markham (CA)

(73) Assignee: ATI Technologies ULC, Markham (CA)

(21) Appl. No.: 18/335,861

(22) Filed: Jun. 15, 2023

(51) Int. Cl. G06F 21/44; G06F 9/455

(52) U.S. Cl. CPC G06F 21/44; G06F 9/45558; G06F 2009/45587

(57) ABSTRACT

The disclosed computing device can include guest circuitry configured to provide a virtual function, authorization circuitry configured to authorize host circuitry to access an architecture performance counter for the virtual function, and security circuitry configured to perform a security action based on the authorization. Various other methods, systems, and computer-readable media are also disclosed.

### BACKGROUND

Several side-channel and covert-channel attacks exploit architecture performance counters (APCs) to exfiltrate guest's confidential information such as guest memory map, guest software libraries, machine learning models, SSL keys, etc. Preventing these side-channel and covert-channel attacks facilitates confidential compute. Information processing standards (e.g., Federal Information Processing Standard (FIPS 140-3)) certification requires resistivity against side-channel attacks and incorporation of different countermeasures. Furthermore, these attacks impact all processor/gaming platform vendors.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a block diagram of an example system for implementing secure performance counters for guest virtual machines.

FIG. 2 is a block diagram of an additional example system for implementing secure performance counters for guest virtual machines.

FIG. 3 is a flow diagram of an example method for implementing secure performance counters for guest virtual machines.

FIG. 4 is a block diagram of an example virtualization environment including a secure processor for implementing secure performance counters for guest virtual machines.

FIG. 5 is a block diagram of example security settings for implementing secure performance counters for guest virtual machines.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to systems and methods for implementing secure performance counters for guest virtual machines. Architecture performance counters (APCs) provide valuable information about CPU, caches, memory, input-output (IO), power, etc. Sometimes these APCs can be selectively configured by a malicious hypervisor (HV) to track specific guest virtual machine (VM) activities. For example, input-output memory management unit (IOMMU) APCs can be configured to track specific bus/device/function (BDF) and domain identifiers (IDs) belonging to secure guests.

The disclosed systems and methods can ensure that, in a trusted execution environment with a malicious HV, access to APCs can be enabled only by the secure processor, as opposed to the hypervisor, and pre-approved by the guest. For example, the disclosed techniques can authorize a host circuitry to access an architecture performance counter for the virtual function, and performing, by the at least one processor, a security action based on the authorization. Advantageously, the disclosed techniques can thwart side-channel and covert-channel attacks on guest VMs due to unfettered access to APCs by a malicious hypervisor and/or malicious guests.

In one example, a computing device includes guest circuitry configured to provide a virtual function, authorization circuitry configured to authorize a host circuitry to access an architecture performance counter for the virtual function, and security circuitry configured to perform a security action based on the authorization.

Another example can be the previously described example computing device, wherein the security action includes providing, to the host circuitry, the architecture performance counter at least partly in response to a security setting indicating that the host circuitry is authorized to receive the architecture performance counter.

Another example can be any of the previously described example computing devices, wherein the security circuitry is configured to receive a request for the architecture performance counter from the host circuitry and provide the architecture performance counter to the host circuitry further in response to the request.

Another example can be any of the previously described example computing devices, wherein the request includes information indicating at least one of one or more intended uses of the architecture performance counter or at least one of a particular hypervisor corresponding to a physical function provided by the host circuitry or a particular type of the particular hypervisor corresponding to the physical function.

Another example can be any of the previously described example computing devices, wherein the security setting includes at least one of at least one trusted hypervisor security setting authorizing at least one of the particular hypervisor or the particular type of the particular hypervisor to receive the architecture performance counter or at least one trusted use security setting authorizing the one or more intended uses of the architecture performance counter.

Another example can be any of the previously described example computing devices, wherein the authorization circuitry is configured to authorize the host circuitry based on at least one of the at least one trusted hypervisor security setting or the at least one trusted use security setting.

Another example can be any of the previously described example computing devices, wherein the security circuitry is configured to communicate a prompt, in response to the request, to a user interacting with the virtual function, wherein the prompt is configured to communicate, to the user, the information indicating at least one of the at least one of the particular hypervisor or the particular type of the particular hypervisor or the one or more intended uses of the architecture performance counter.

Another example can be any of the previously described example computing devices, the security circuitry is configured to receive user input from the user interacting with the virtual function and the authorization circuitry is configured to modify the security setting based on the user input.

Another example can be any of the previously described example computing devices, wherein the authorization circuitry is configured to maintain the architecture performance counter.

Another example can be any of the previously described example computing devices, further including additional guest circuitry configured to provide an additional virtual function, wherein the security circuitry is configured to receive a request for the architecture performance counter from the additional guest circuitry, the authorization circuitry is configured to additionally authorize the additional guest circuitry to access the architecture performance counter, and the security circuitry is configured to provide the architecture performance counter to the additional guest circuitry based on the additional authorization.

In one example, a server system can include host circuitry configured to provide a physical function and guest circuitry configured to provide a virtual function, authorize the host circuitry to access an architecture performance counter for the virtual function, and perform a security action based on the authorization.

Another example can be the previously described example server system, wherein the security action includes providing, to the host circuitry, the architecture performance counter at least partly in response to a security setting indicating that the host circuitry is authorized to receive the architecture performance counter.

Another example can be any of the previously described example server systems, wherein the guest circuitry is configured to receive a request for the architecture performance counter from the host circuitry and provide the architecture performance counter to the host circuitry further in response to the request.

Another example can be any of the previously described example server systems, wherein the request includes information indicating at least one of one or more intended uses of the architecture performance counter or at least one of a particular hypervisor corresponding to a physical function provided by the host circuitry or a particular type of the particular hypervisor corresponding to the physical function.

Another example can be any of the previously described example server systems, wherein the security setting includes at least one of at least one trusted hypervisor security setting authorizing at least one of the particular hypervisor or the particular type of the particular hypervisor to receive the architecture performance counter or at least one trusted use security setting authorizing the one or more intended uses of the architecture performance counter.

Another example can be any of the previously described example server systems, wherein the guest circuitry is configured to authorize the host circuitry based on at least one of the at least one trusted hypervisor security setting or the at least one trusted use security setting.

Another example can be any of the previously described example server systems, wherein the guest circuitry is configured to communicate a prompt, in response to the request, to a user interacting with the virtual function, wherein the prompt is configured to communicate, to the user, the information indicating at least one of the at least one of the particular hypervisor or the particular type of the particular hypervisor or the one or more intended uses of the architecture performance counter.

Another example can be any of the previously described example server systems, further including additional guest circuitry configured to provide an additional virtual function, wherein the guest circuitry is configured to receive a request for the architecture performance counter from the additional guest circuitry, additionally authorize the additional guest circuitry to access the architecture performance counter, and provide the architecture performance counter to the additional guest circuitry based on the additional authorization.

In one example, a computer-implemented method includes providing, by at least one processor, a virtual function, authorizing, by the at least one processor, a host circuitry to access an architecture performance counter for the virtual function, and performing, by the at least one processor, a security action based on the authorization.

Another example can be the previously described example computer-implemented method, further including receiving a request for the architecture performance counter from an additional guest circuitry configured to provide an additional virtual function, additionally authorize the additional guest circuitry to access the architecture performance counter and provide the architecture performance counter to the additional guest circuitry based on the additional authorization.

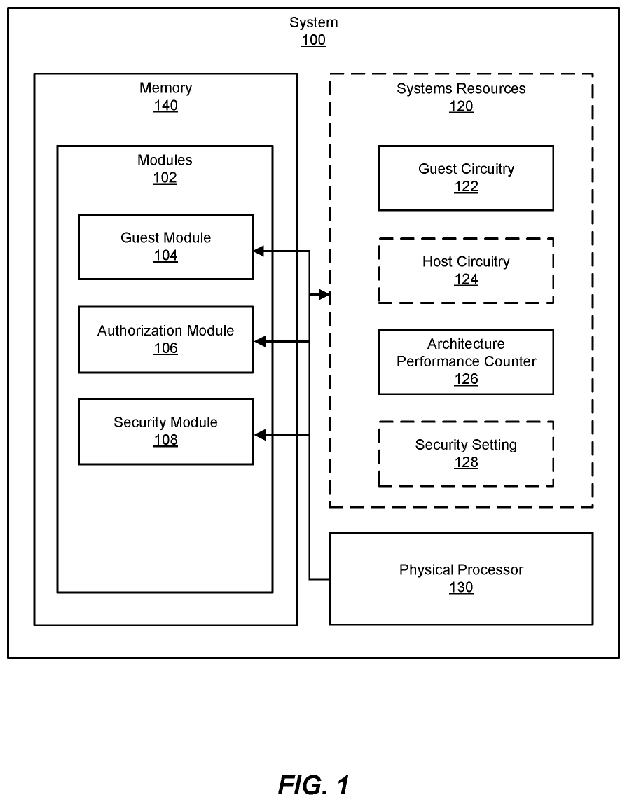

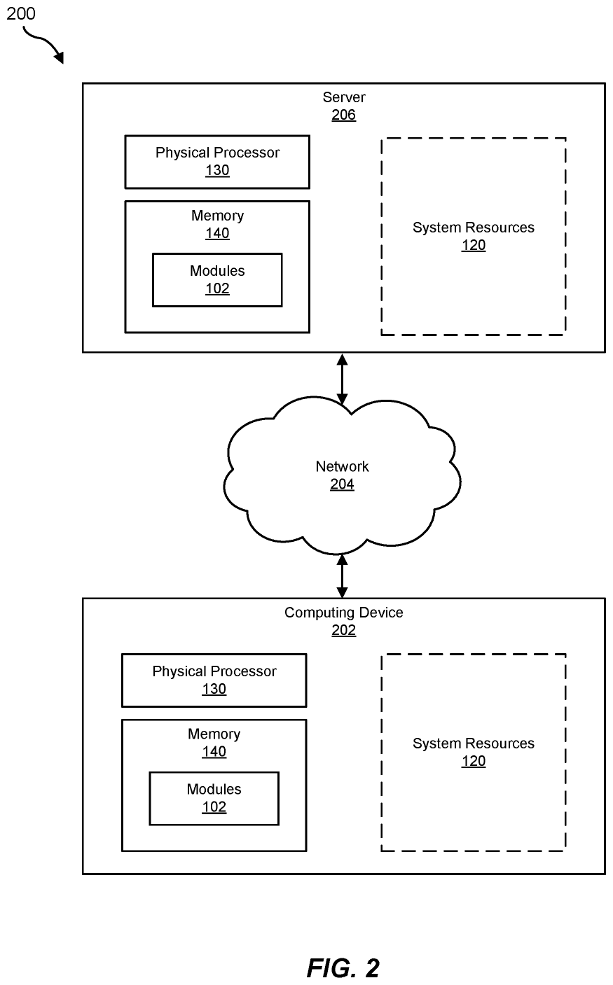

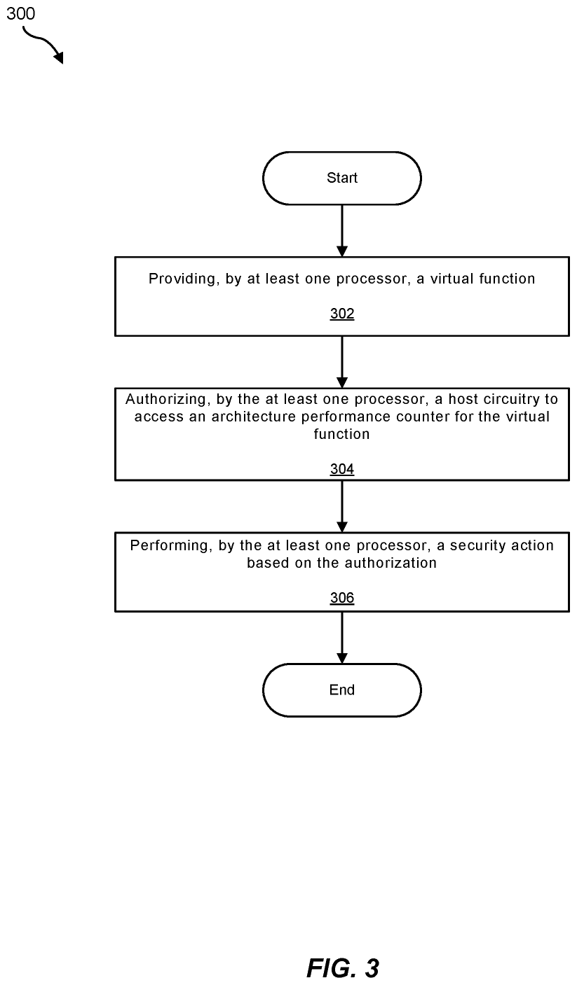

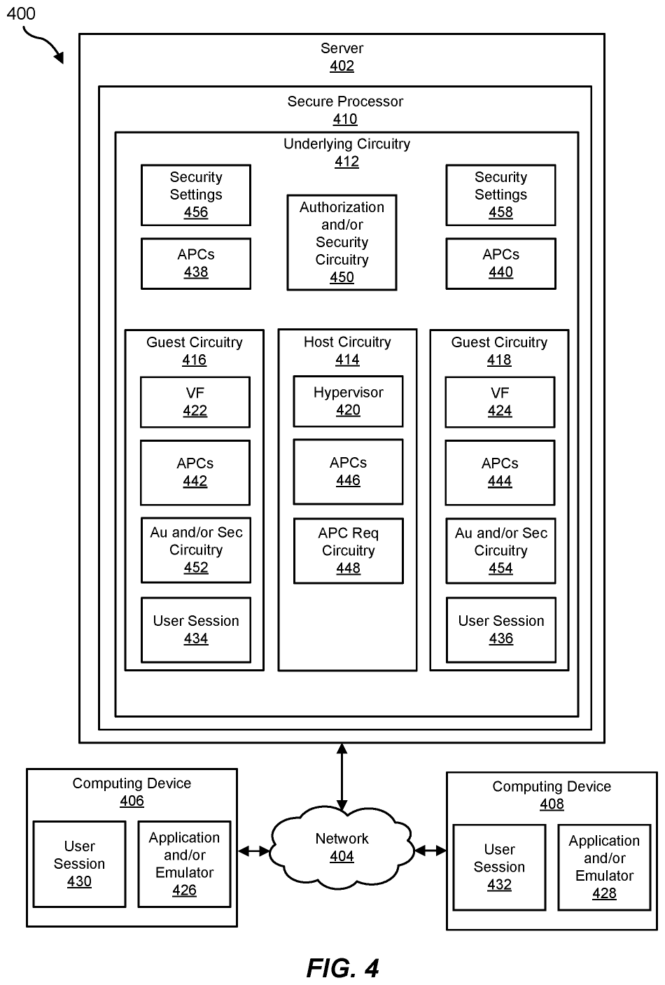

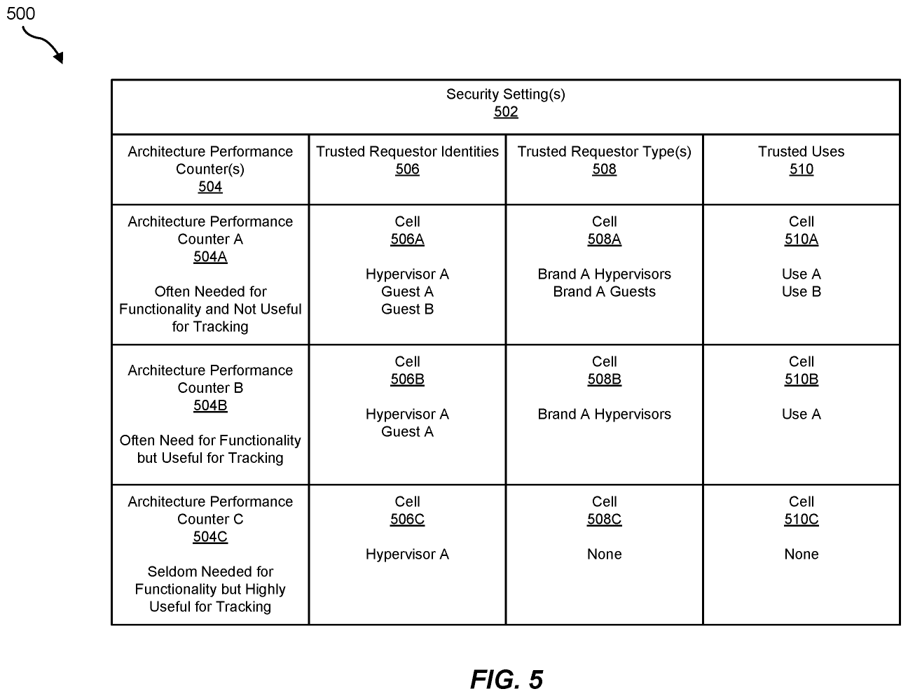

The following will provide, with reference to FIGS. 1-2, detailed descriptions of example systems for implementing secure performance counters for guest virtual machines. Detailed descriptions of corresponding computer-implemented methods will also be provided in connection with FIG. 3. In addition, detailed descriptions of an example virtualization environment including a secure processor for implementing secure performance counters for guest virtual machines will be provided with reference to FIG. 4. Further, detailed descriptions of example security settings for implementing secure performance counters for guest virtual machines will be provided in connection with FIG. 5.

FIG. 1 is a block diagram of an example system 100 for implementing secure performance counters for guest virtual machines. As illustrated in this figure, example system 100 can include one or more modules 102 for performing one or more tasks. As will be explained in greater detail below, modules 102 can include a guest module 104, an authorization module 106, and a security module 108. Although illustrated as separate elements, one or more of modules 102 in FIG. 1 can represent portions of a single module or application.

In certain implementations, one or more of modules 102 in FIG. 1 can represent one or more software applications or programs that, when executed by a computing device, can cause the computing device to perform one or more tasks. For example, and as will be described in greater detail below, one or more of modules 102 can represent modules stored and configured to run on one or more computing devices, such as the devices illustrated in FIG. 2 (e.g., computing device 202 and/or server 206). One or more of modules 102 in FIG. 1 can also represent all or portions of one or more special-purpose computers configured to perform one or more tasks.

As illustrated in FIG. 1, example system 100 can also include one or more memory devices, such as memory 140. Memory 140 generally represents any type or form of volatile or non-volatile storage device or medium capable of storing data and/or computer-readable instructions. In one example, memory 140 can store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As illustrated in FIG. 1, example system 100 can also include one or more physical processors, such as physical processor 130. Physical processor 130 generally represents any type or form of hardware-implemented processing unit capable of interpreting and/or executing computer-readable instructions. In one example, physical processor 130 can access and/or modify one or more of modules 102 stored in memory 140. Additionally or alternatively, physical processor 130 can execute one or more of modules 102 to facilitate implementing secure performance counters for guest virtual machines. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As illustrated in FIG. 1, example system 100 can also include one or more system resources, such as system resources 120. System resources 120 generally represents any type or form of circuits (e.g., hardware, software, firmware, digital circuits, analog circuits, or combinations thereof) and/or stored data, however stored (e.g., signal line transmissions, bit registers, flip flops, software in rewritable memory, configurable hardware states, combinations thereof, etc.). In one example, system resources 120 includes underlying hardware, firmware, processing blocks, major and/or minor operating systems, databases, spreadsheets, tables, lists, matrices, trees, or any other type of data structure. Examples of system resources 120 include, without limitation, guest circuitry 122, host circuitry 124, architecture performance counter 126, and security setting 128.

Example system 100 in FIG. 1 can be implemented in a variety of ways. For example, all or a portion of example system 100 can represent portions of example system 200 in FIG. 2. As shown in FIG. 2, system 200 can include a computing device 202 in communication with a server 206 via a network 204. In one example, all or a portion of the functionality of modules 102 can be performed by computing device 202, server 206, and/or any other suitable computing system. As will be described in greater detail below, one or more of modules 102 from FIG. 1 can, when executed by at least one processor of computing device 202 and/or server 206, enable computing device 202 and/or server 206 to implement secure performance counters for guest virtual machines.

Computing device 202 generally represents any type or form of computing device capable of reading computer-executable instructions. In some implementations, computing device 202 can be and/or include a graphics processing unit having a chiplet processor connected by a switch fabric. Additional examples of computing device 202 include, without limitation, laptops, tablets, desktops, servers, cellular phones, Personal Digital Assistants (PDAs), multimedia players, embedded systems, wearable devices (e.g., smart watches, smart glasses, etc.), smart vehicles, so-called Internet-of-Things devices (e.g., smart appliances, etc.), gaming consoles, variations or combinations of one or more of the same, or any other suitable computing device.

Server 206 generally represents any type or form of computing device that is capable of reading computer-executable instructions. In some implementations, computing device 202 can be and/or include a cloud service (e.g., cloud gaming server) that includes a graphics processing unit having a chiplet processor connected by a switch fabric. Additional examples of server 206 include, without limitation, storage servers, database servers, application servers, and/or web servers configured to run certain software applications and/or provide various storage, database, and/or web services. Although illustrated as a single entity in FIG. 2, server 206 can include and/or represent a plurality of servers that work and/or operate in conjunction with one another.

Network 204 generally represents any medium or architecture capable of facilitating communication or data transfer. In one example, network 204 can facilitate communication between computing device 202 and server 206. In this example, network 204 can facilitate communication or data transfer using wireless and/or wired connections. Examples of network 204 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, or any other suitable network.

Many other devices or subsystems can be connected to system 100 in FIG. 1 and/or system 200 in FIG. 2. Conversely, all of the components and devices illustrated in FIGS. 1 and 2 need not be present to practice the implementations described and/or illustrated herein. The devices and subsystems referenced above can also be interconnected in different ways from that shown in FIG. 2. Systems 100 and 200 can also employ any number of software, firmware, and/or hardware configurations. For example, one or more of the example implementations disclosed herein can be encoded as a computer program (also referred to as computer software, software applications, computer-readable instructions, and/or computer control logic) on a computer-readable medium.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

FIG. 3 is a flow diagram of an example computer-implemented method 300 for implementing secure performance counters for guest virtual machines. The steps shown in FIG. 3 can be performed by any suitable computer-executable code and/or computing system, including system 100 in FIG. 1, system 200 in FIG. 2, and/or variations or combinations of one or more of the same. In one example, each of the steps shown in FIG. 3 can represent an algorithm whose structure includes and/or is represented by multiple sub-steps, examples of which will be provided in greater detail below.

As illustrated in FIG. 3, at step 302 one or more of the systems described herein can provide a virtual function. For example, guest module 104 can, as part of computing device 202 in FIG. 2, provide, by at least one processor, a virtual function.

The term “guest circuitry,” as used herein, can generally refer to underlying hardware. For example, and without limitation, guest circuitry can refer to the underlying hardware that provides a functional hardware instance to an operating system and application software that is completely separate and independent from host circuitry.

The term “virtual function,” as used herein, can generally refer to a function on a network, graphics, or GPU adapter. For example, and without limitation, virtual function can refer to a PCI Express (PCIe) Virtual Function (VF) that is a lightweight PCIe function on the adapter that supports single root I/O virtualization (SR-IOV). The virtual function can be associated with a PCIe Physical Function (PF) on the adapter and represent a virtualized instance of the adapter. Each virtual function can have its own PCI Configuration space. Each virtual function can also share one or more physical resources on the adapter, such as device memory, with the physical function and other virtual functions.

The systems described herein can perform step 302 in a variety of ways. In some examples, guest module 104 can, as part of computing device 202 in FIG. 2, provide a virtual function associated with a child partition in a virtualized environment. In some examples, guest module 104 can correspond to a graphics processing unit (GPU) of a server system, such as server 206 of FIG. 2.

The term “child partition,” as used herein, can generally refer to a type of hard disk partition used in virtualization environments. For example, and without limitation, the child partition can be a logical hard drive partition used specifically by virtual machines to store and retrieve their native operating system, data, and applications.

The term “virtualized environment,” as used herein, can generally refer to an operating system environment where multiple virtual machines can run on a single physical machine or cluster, sharing the physical machine resources. For example, and without limitation, in a virtualized environment, a virtual processor can run on only one physical processor at a time.

At step 304, one or more of the systems described herein can authorize a host circuitry. For example, authorization module 106 can, as part of computing device 202 in FIG. 2, authorize, by the at least one processor, a host circuitry to access an architecture performance counter for the virtual function.

The term “host circuitry,” as used herein, can generally refer to underlying hardware. For example, and without limitation, host circuitry can refer to the underlying hardware that provides computing resources, such as processing power, memory, disk and network I/O. For example, host circuitry can provide a physical function as part of a parent partition in a virtualized environment.

The term “physical function,” as used herein, can generally refer to a network, graphics, or GPU adapter. For example, and without limitation, physical function can refer to a PCI Express (PCIe) function of an adapter that supports the single root I/O virtualization (SR-IOV) interface. In some examples, the physical function can include the SR-IOV Extended Capability in the PCIe Configuration space. This capability can be used to configure and manage the SR-IOV functionality of the adapter, such as enabling virtualization and exposing PCIe Virtual Functions. The physical function can be exposed as a physical adapter in the management operating system of a hypervisor parent partition.

The term “hypervisor parent partition,” as used herein, can generally refer to an instance of partition within a virtualization environment that is responsible for running a virtualization stack and creating child partitions. For example, and without limitation, the parent partition can be the second layer of partition after a root partition. In some examples, the parent partition can directly interface with hardware and logical virtualization resources.

The term “architecture performance counter,” as used herein, can generally refer to one or more registers that store counts of hardware related activities. For example, and without limitation, architecture performance counters can be a set of special-purpose registers built into microprocessors to store the counts of hardware-related activities within computer systems. Advanced users often rely on those counters to conduct low-level performance analysis or tuning.

The systems described herein can perform step 304 in a variety of ways. For example, authorization module 106 can, as part of computing device 202 in FIG. 2, maintain the architecture performance counter. Alternatively or additionally, authorization module 106 can, as part of computing device 202 in FIG. 2, authorize the host circuitry based on at least one of the at least one trusted hypervisor security setting or the at least one trusted use security setting. Alternatively or additionally, authorization module 106 can, as part of computing device 202 in FIG. 2, modify the security setting based on ser input. Alternatively or additionally, the security setting can include at least one of at least one trusted hypervisor security setting authorizing at least one of the particular hypervisor or the particular type of the particular hypervisor to receive the architecture performance counter or at least one trusted use security setting authorizing the one or more intended uses of the architecture performance counter. Alternatively or additionally, authorization module 106 can, as part of computing device 202 in FIG. 2, authorize the host circuitry based on at least one of the at least one trusted hypervisor security setting or the at least one trusted use security setting. Alternatively or additionally, authorization module 106 can, as part of computing device 202 in FIG. 2, additionally authorize an additional guest circuitry to access the architecture performance counter. In some examples, the authorization circuitry can correspond to a trusted micro-processor (e.g., Root of Trust (ROT) of a GPU of a server system, such as server 206 of FIG. 2.

At step 306, one or more of the systems described herein can perform a security action. For example, security module 108 can, as part of computing device 202 in FIG. 2, perform, by the at least one processor, a security action based on the authorization.

The term “security action,” as used herein, can generally refer to a programmed response taken by a computer processor. For example, and without limitation, security action may refer to granting access, denying access, generating an alert, etc.

The systems described herein can perform step 306 in a variety of ways. For example, security module 108 can, as part of computing device 202 in FIG. 2, perform the security action by providing, to the host circuitry, the architecture performance counter at least partly in response to a security setting indicating that the host circuitry is authorized to receive the architecture performance counter. Alternatively or additionally, security module 108 can, as part of computing device 202 in FIG. 2, perform the security action by receiving a request for the architecture performance counter from the host circuitry and provide the architecture performance counter to the host circuitry further in response to the request. Alternatively or additionally, security module 108 can, as part of computing device 202 in FIG. 2, perform the security action by receiving a request that includes information indicating at least one of one or more intended uses of the architecture performance counter or at least one of a particular hypervisor corresponding to a physical function provided by the host circuitry or a particular type of the particular hypervisor corresponding to the physical function. Alternatively or additionally, security module 108 can, as part of computing device 202 in FIG. 2, perform the security action by communicating a prompt, in response to the request, to a user interacting with the virtual function, wherein the prompt is configured to communicate, to the user, the information indicating at least one of the at least one of the particular hypervisor or the particular type of the particular hypervisor or the one or more intended uses of the architecture performance counter. Alternatively or additionally, security module 108 can, as part of computing device 202 in FIG. 2, perform the security action by receiving user input from the user interacting with the virtual function. Alternatively or additionally, security module 108 can, as part of computing device 202 in FIG. 2, receive a request for the architecture performance counter from an additional guest circuitry configured to provide an additional virtual function and provide the architecture performance counter to the additional guest circuitry based on the additional authorization. In some examples, the authorization circuitry can correspond to a trusted micro-processor (e.g., Root of Trust (ROT) of a GPU of a server system, such as server 206 of FIG. 2.

The implementations described above can address an issue relating to side channel attacks by other guest circuitry in which the other guest circuitry can access performance counters that leak information for the guest circuitry. For example, if the other guest circuitry can use performance counters to track cache misses and if the guest circuitry is the only other guest active, then the guest circuitry's memory access information can be leaked in a side-channel attack. When this leak occurs with the guest circuitry's consent, it can result in a covert channel between the guest circuitry and the other guest circuitry in which the guest circuitry causes a counter value to change and the other guest circuitry reads it in a covert channel attack. Such attacks do not require the hypervisor's involvement. To thwart these attacks, the secure processor can deny the other guest circuitry access those performance counters that could be used to track the guest circuitry.

Referring to FIG. 4, an example virtualized environment 400 includes a server 402 (e.g., cloud services server, cloud gaming server, etc.), connected over a communications network 404 (e.g., intranet, WAN, LAN, PAN, the Internet, PLC, cellular network, etc.) and computing devices 406 and 408 (e.g., personal computers, mobile devices, gaming consoles, etc.). Server 402 can include a secure processor 410 for implementing secure performance counters for guest virtual machines, and secure processor 410 can have underlying circuitry 412 with appropriate software (e.g., operating system, system kernel, device drivers, etc.) that, in combination with host circuitry 414 and one or more instances of guest circuitry 416 and 418, can provide the virtualized environment 400.

In some examples, host circuitry 414 and guest circuitry 416 and 418 can be hardware blocks (e.g., firmware) having minor operating systems and be configured to operate as containers for system images. Accordingly, underlying circuitry 412 can enable the corresponding hardware blocks to operate as the host circuitry 414 and guest circuitry 416 and 418. With such configurations, host circuitry can provide a hypervisor 420 and guest circuitry 416 and 418 can provide respective virtual functions 422 and 424. Hypervisor 420 can run an application for the server 402 and virtual functions 422 and 424 can run respective applications (e.g., cloud gaming software) for computing devices 406 and 408. In some implementations, computing devices 406 and 408 also can run applications and/or emulators 426 and 428 that synchronize with their respective virtual functions 422 and 424. In some examples, computing devices 406 and 408 can also store and maintain respective user sessions 430 and 432 (e.g., game save data, user preferences, etc.) that can be copied to their respective guest circuitry 416 and 418 and stored as user sessions 434 and 436. Alternatively or additionally, guest circuitry 416 and 418 can store and maintain these user sessions 434 and 436 for their respective computing devices 406 and 408.

Unlike previous virtualized environments, hypervisor 420 of the example virtualized environment 400 is not allowed to enable architecture performance counters for guest circuitry 416 and 418. Instead, secure processor 410 can enable the architecture performance counters 438 and 440, which can be maintained by underlying circuitry 412 as architecture performance counters 438 and 440 and/or by guest circuitry 416 and 418 as architecture performance counters 442 and 444. However, to obtain any of the architecture performance counters 438-444 and store them at host circuitry as architecture performance counters 446, hypervisor 420 can utilize APC request circuitry 448 of host circuitry 414 to request the architecture performance counters 438-444. Such a request can be received and processed by authorization and/or security circuitry 450 of underlying circuitry 412 and/or authorization and/or security circuitry 452 and 454 of respective guest circuitry 416 and 418.

In some implementations, the request can identify the requested counters, the hypervisor 420, a type (e.g., brand, cloud game name, etc.) of the hypervisor, and/or intended uses (e.g., necessary for functionality, trouble shooting, monetization, etc.) of the requested architecture performance counters. In turn, authorization and/or security circuitry 450 can determine, based on security settings 456 and 458 maintained by the underlying circuitry 412, if the hypervisor is authorized to receive any of the requested architecture performance counters. Alternatively or additionally, authorization and/or security circuitry 452 and/or 454 can determine, based on security settings maintained as part of user sessions 434 and 436 (e.g., user preferences), if the hypervisor 420 is authorized to receive any of the requested architecture performance counters. In some implementations, authorization and/or security circuitry 450, 452, and/or 454 can consult both security settings 456 and/or 458 (e.g., default and/or recommended security settings) and user sessions 434 and/or 436 (e.g., user preferences).

As part of the determinations performed by authorization and/or security circuitry 450-454, one or more of authorization and/or security circuitry 450-454 can communicate a prompt to users of the computing devices 406 and 408 asking if they wish to authorize hypervisor 420 to receive their respective architecture performance counters as requested by the hypervisor 420. In some implementations, users can authorize particular hypervisors, particular types of hypervisors, and/or particular uses of their respective architecture performance counters. In some of these implementations, users can provide different responses for different types of architecture performance counters. User responses can be recorded in security settings 456 and 458 and/or user sessions 430-436 for subsequent reference. Thus, authorization and/or security circuitry 450-454 can prompt users in response to an absence of defined security settings 456 and 458 and/or relevant user preferences in user sessions 430-436.

Similarly, authorization and/or security circuitry 450-454 can receive similar requests from guest circuitry 416 and/or 418 and process these requests in similar fashion. Thus, in some examples, users can also authorize guest circuitry 416 and/or 418 of other users to receive their respective architecture performance counters 438-444 based on a particular virtual function (e.g., other user identity), particular type of the other user (e.g., in the user's friends list, currently engaged in cooperative play with the user, etc.), and/or intended uses by the other user and/or virtual function requesting the architecture performance counters.

Referring to FIG. 5, example security settings 500 (e.g., user preferences) are shown in the form of a security settings table 502 but can take any number of forms or formats. Column headings of the example table 502 can include architecture performance counters 504, trusted requestor identities 506, trusted requestor types 508, and trusted uses 510. The first column can define rows corresponding to particular architecture performance counters 504A-504C and/or particular types of performance counters. In some implementations, the rows can be arranged in an ascending or descending order according to usefulness of the performance counters 504A-504C, such as a whether the architecture performance counter is often needed for functionality (e.g., necessary APCs) and/or usefulness for side channel tracking. In some implementations, a prompt to a user, as described above, can take the form of table 502 populated with default and/or recommended settings for the user to confirm, modify, and/or override. In some examples, the prompt can convey information about the usefulness (e.g., associated risks) of the architecture performance counters and/or the intended uses of those counters by one or more requestors. Accordingly, a user can create and/or modify contents of cells 506A-506C, 508A-508C, and/or 510A-510C to grant or deny access to individual requestors (e.g., hypervisors and/or other guests), types of requestors (e.g., brands, friends list members, etc.), and/or intended uses as previously described. The confirmed and/or modified table 502 can be applied in determining whether to grant access to a requestor and also stored for later use.

As set forth above, the disclosed systems and methods can obtain guest pre-approval for a hypervisor and/or another guest to trace guest activities (e.g., input/output translation lookaside buffer (IOTLB) invalidations). The disclosed techniques can ensure that the guest is aware when it is being profiled and for what type of activities. To this end, programming of architecture performance counters to monitor guest activities can be delegated to a secure processor and/or secure firmware as opposed to the hypervisor. In this way, a malicious hypervisor can be prevented from programming any architecture performance counter to trace guest activities except as approved by the guest. The secure processor can also ensure that a guest does not approve access to its APCs by another guest, thus preventing two or more malicious guests from colluding and establishing covert communication channels via architecture performance counters. The disclosed techniques further avoid blanket banning all architecture performance counters across all users for security. Nor do the disclosed techniques require any changes to guest software/application (e.g., application hardening for security).

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

In various implementations, all or a portion of example system 100 in FIG. 1 can facilitate multi-tenancy within a cloud-based computing environment. In other words, the modules described herein can configure a computing system (e.g., a server) to facilitate multi-tenancy for one or more of the functions described herein. For example, one or more of the modules described herein can program a server to enable two or more clients (e.g., customers) to share an application that is running on the server. A server programmed in this manner can share an application, operating system, processing system, and/or storage system among multiple customers (i.e., tenants). One or more of the modules described herein can also partition data and/or configuration information of a multi-tenant application for each customer such that one customer cannot access data and/or configuration information of another customer.

According to various implementations, all or a portion of example system 100 in FIG. 1 can be implemented within a virtual environment. For example, the modules and/or data described herein can reside and/or execute within a virtual machine. As used herein, the term “virtual machine” generally refers to any operating system environment that is abstracted from computing hardware by a virtual machine manager (e.g., a hypervisor).

In some examples, all or a portion of example system 100 in FIG. 1 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computing device, comprising:
guest circuitry configured to provide a virtual function;
authorization circuitry configured to authorize host circuitry to access an architecture performance counter for the virtual function; and
security circuitry configured to perform a security action based on the authorization.

2. The computing device of claim 1, wherein the security action includes providing, to the host circuitry, the architecture performance counter at least partly in response to a security setting indicating that the host circuitry is authorized to receive the architecture performance counter.

3. The computing device of claim 2, wherein the security circuitry is configured to:
receive a request for the architecture performance counter from the host circuitry; and
provide the architecture performance counter to the host circuitry further in response to the request.

4. The computing device of claim 3, wherein the request includes information indicating at least one of:
one or more intended uses of the architecture performance counter; or
at least one of a particular hypervisor corresponding to a physical function provided by the host circuitry or a particular type of the particular hypervisor corresponding to the physical function.

5. The computing device of claim 4, wherein the security setting includes at least one of:
at least one trusted hypervisor security setting authorizing at least one of the particular hypervisor or the particular type of the particular hypervisor to receive the architecture performance counter; or
at least one trusted use security setting authorizing the one or more intended uses of the architecture performance counter.

6. The computing device of claim 5, wherein the authorization circuitry is configured to authorize the host circuitry based on at least one of:
the at least one trusted hypervisor security setting; or
the at least one trusted use security setting.

7. The computing device of claim 4, wherein the security circuitry is configured to communicate a prompt, in response to the request, to a user interacting with the virtual function, wherein the prompt is configured to communicate, to the user, the information indicating at least one of:
the at least one of the particular hypervisor or the particular type of the particular hypervisor; or
the one or more intended uses of the architecture performance counter.

8. The computing device of claim 7, wherein:
the security circuitry is configured to receive user input from the user interacting with the virtual function; and
the authorization circuitry is configured to modify the security setting based on the user input.

9. The computing device of claim 1, wherein the authorization circuitry is configured to maintain the architecture performance counter.

10. The computing device of claim 1, further comprising additional guest circuitry configured to provide an additional virtual function, wherein:
the security circuitry is configured to receive a request for the architecture performance counter from the additional guest circuitry;
the authorization circuitry is configured to additionally authorize the additional guest circuitry to access the architecture performance counter; and
the security circuitry is configured to provide the architecture performance counter to the additional guest circuitry based on the additional authorization.

11. A server system comprising:
host circuitry configured to provide a physical function; and
guest circuitry configured to provide a virtual function, authorize the host circuitry to access an architecture performance counter for the virtual function, and perform a security action based on the authorization.

12. The server system of claim 11, wherein the security action includes providing, to the host circuitry, the architecture performance counter at least partly in response to a security setting indicating that the host circuitry is authorized to receive the architecture performance counter.

13. The server system of claim 12, wherein the guest circuitry is configured to:
receive a request for the architecture performance counter from the host circuitry; and
provide the architecture performance counter to the host circuitry further in response to the request.

14. The server system of claim 13, wherein the request includes information indicating at least one of:
one or more intended uses of the architecture performance counter; or
at least one of a particular hypervisor corresponding to a physical function provided by the host circuitry or a particular type of the particular hypervisor corresponding to the physical function.

15. The server system of claim 14, wherein the security setting includes at least one of:
at least one trusted hypervisor security setting authorizing at least one of the particular hypervisor or the particular type of the particular hypervisor to receive the architecture performance counter; or
at least one trusted use security setting authorizing the one or more intended uses of the architecture performance counter.

16. The server system of claim 15, wherein the guest circuitry is configured to authorize the host circuitry based on at least one of:
the at least one trusted hypervisor security setting; or
the at least one trusted use security setting.

17. The server system of claim 14, wherein the guest circuitry is configured to communicate a prompt, in response to the request, to a user interacting with the virtual function, wherein the prompt is configured to communicate, to the user, the information indicating at least one of:
the at least one of the particular hypervisor or the particular type of the particular hypervisor; or
the one or more intended uses of the architecture performance counter.

18. The server system of claim 11, further comprising additional guest circuitry configured to provide an additional virtual function, wherein the guest circuitry is configured to receive a request for the architecture performance counter from the additional guest circuitry, additionally authorize the additional guest circuitry to access the architecture performance counter, and provide the architecture performance counter to the additional guest circuitry based on the additional authorization.

19. A computer-implemented method comprising:
providing, by at least one processor, a virtual function;
authorizing, by the at least one processor, host circuitry to access an architecture performance counter for the virtual function; and
performing, by the at least one processor, a security action based on the authorization.

20. The computer-implemented method of claim 19, further comprising:
receiving a request for the architecture performance counter from an additional guest circuitry configured to provide an additional virtual function;
additionally authorize the additional guest circuitry to access the architecture performance counter; and
provide the architecture performance counter to the additional guest circuitry based on the additional authorization.
